(19) United States
(12) Patent Application Publication
(10) Pub. No.: US 2025/0029030 A1
(43) Pub. Date: Jan. 23, 2025

(54) WORK SUPPORT SYSTEM, WORK SUPPORT APPARATUS, WORK SUPPORT METHOD, AND NON-TRANSITORY COMPUTER READABLE MEDIUM

(71) Applicant: NEC Corporation, Tokyo (JP)

(72) Inventors: Akira TSUJI, Tokyo (JP); Ryusuke Imai, Tokyo (JP)

(73) Assignee: NEC Corporation, Tokyo (JP)

(21) Appl. No.: 18/761,605

(22) Filed: Jul. 2, 2024

(30) Foreign Application Priority Data
Jul. 21, 2023 (JP) 2023-119288

(51) Int. Cl. G06Q 10/0631

(52) U.S. Cl. CPC G06Q 10/063114; G06Q 10/063112

(57) ABSTRACT

The extraction unit extracts at least one piece of work support information, according to an extraction condition, from a work support information database storing a plurality of pieces of work support information. The transmission unit transmits the at least one piece of work support information extracted by the extraction unit to augmented reality equipment. The extraction condition is at least any one of a degree of skill of a worker using the augmented reality equipment, a weather history at a work site, a generation date of the work support information, and an information transmitting person of the work support information.

### INCORPORATION BY REFERENCE

This application is based upon and claims the benefit of priority from Japanese patent application No. 2023-119288, filed on Jul. 21, 2023, the disclosure of which is incorporated herein in its entirety by reference.

### TECHNICAL FIELD

The present invention relates to a work support system, a work support apparatus, a work support method, and a non-transitory computer readable medium.

### BACKGROUND ART

Patent Literature 1 (Japanese Unexamined Patent Application Publication No. 2021-051519) discloses a work support system that supports work by a worker by displaying work support information by using a mixed reality (MR) device being worn by the worker on a work site. Specifically, a camera mounted on the MR device captures an image of equipment located ahead of a line of sight of an worker. Based on a capturing result, the work support system reads the work support information related to the equipment located ahead of the line of sight of the worker from a database. The work support information is typically a manual, a specification, or a component list. The work support system transmits the read work support information to the MR device. The MR device displays the received work support information. As a result, an inexperienced worker can be trained in a short period of time.

### SUMMARY

In the configuration of Patent Literature 1 described above, only uniform work support information can be provided to a worker.

In a first example aspect, a work support system includes:
an extraction means for extracting at least one piece of work support information, according to an extraction condition, from a work support information database storing a plurality of pieces of work support information; and
a transmission means for transmitting the at least one piece of work support information extracted by the extraction means to augmented reality equipment, wherein
the extraction condition is at least any one of a degree of skill of a worker using the augmented reality equipment, a weather history at a work site, a generation date of the work support information, and an information transmitting person of the work support information.

In a second example aspect, a work support apparatus includes:
an extraction means for extracting at least one piece of work support information, according to an extraction condition, from a work support information database storing a plurality of pieces of work support information; and
a transmission means for transmitting the at least one piece of work support information extracted by the extraction means to augmented reality equipment, wherein
the extraction condition is at least any one of a degree of skill of a worker using the augmented reality equipment, a weather history at a work site, a generation date of the work support information, and an information transmitting person of the work support information.

In a third example aspect, a work support method includes,

by a computer:
extracting at least one piece of work support information, according to an extraction condition, from a work support information database storing a plurality of pieces of work support information; and
transmitting the extracted at least one piece of work support information to augmented reality equipment, wherein
the extraction condition is at least any one of a degree of skill of a worker using the augmented reality equipment, a weather history at a work site, a generation date of the work support information, and an information transmitting person of the work support information.

In a fourth example aspect, a program causes a computer to function as:
an extraction means for extracting at least one piece of work support information, according to an extraction condition, from a work support information database storing a plurality of pieces of work support information; and
a transmission means for transmitting the at least one piece of work support information extracted by the extraction means to augmented reality equipment, wherein
the extraction condition is at least any one of a degree of skill of a worker using the augmented reality equipment, a weather history at a work site, a generation date of the work support information, and an information transmitting person of the work support information.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a schematic diagram of a work support system according to the present disclosure;

FIG. 2 is an overall schematic diagram of the work support system according to the present disclosure;

FIG. 3 is a block diagram of a work support server according to the present disclosure;

FIG. 4 is a data structure diagram of a work support information database according to the present disclosure;

FIG. 5 is a block diagram of an input apparatus according to the present disclosure;

FIG. 6 is a block diagram of augmented reality equipment according to the present disclosure; and

FIG. 7 is a control flow of the work support system according to the present disclosure.

### EXAMPLE EMBODIMENT

### Outline of the Present Disclosure

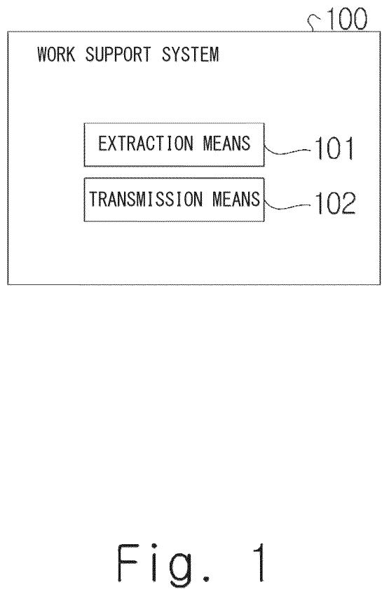

Hereinafter, an outline of a work support system will be described. As illustrated in FIG. 1, a work support system 100 includes an extraction means 101 and a transmission means 102.

The extraction means 101 extracts at least one piece of work support information, according to an extraction condition, from a work support information database storing a plurality of pieces of work support information.

The transmission means 102 transmits the at least one piece of work support information extracted by the extraction means to augmented reality equipment.

The extraction condition is at least any one of a degree of skill of a worker using the augmented reality equipment, a weather history at a work site, a generation date of the work support information, and an information transmitting person of the work support information.

According to the above configuration, it is possible to provide optimized work support information to a worker carrying the augmented reality equipment.

### First Example Embodiment

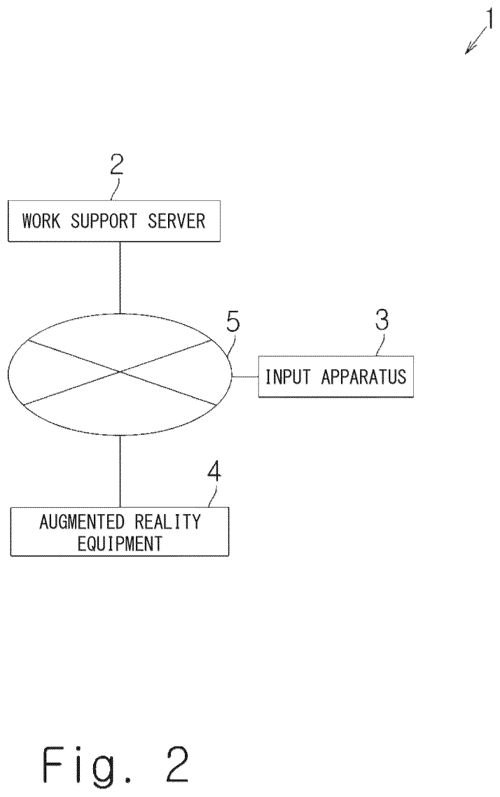

Next, a first example embodiment of the present disclosure will be described. FIG. 2 is an overall schematic diagram of a work support system 1. As illustrated in FIG. 2, the work support system 1 includes a work support server 2, an input apparatus 3, and augmented reality equipment 4.

The work support server 2 and the input apparatus 3 are configured to be capable of performing bidirectional communication via a wide area network (WAN) 5 such as the Internet. Similarly, the work support server 2 and the augmented reality equipment 4 are configured to be capable of performing bidirectional communication via the WAN 5. The input apparatus 3 and the augmented reality equipment 4 may be configured to be capable of performing bidirectional communication via a local area network (LAN). The work support server 2 is achieved by a single apparatus. However, in place of this, the work support server 2 may be achieved by distributed processing by a plurality of apparatuses. The input apparatus 3 is achieved by a single apparatus. However, in place of this, the input apparatus 3 may be achieved by distributed processing by a plurality of apparatuses.

A worker performs work while acquiring various pieces of information from the augmented reality equipment 4 in real time at a work site. The work site is a substation, as one example. A worker performs maintenance and inspection of various facilities at the substation. The various facilities include, for example, a transformer, a circuit breaker, a disconnector, an instrument transformer, and a lightning arrester.

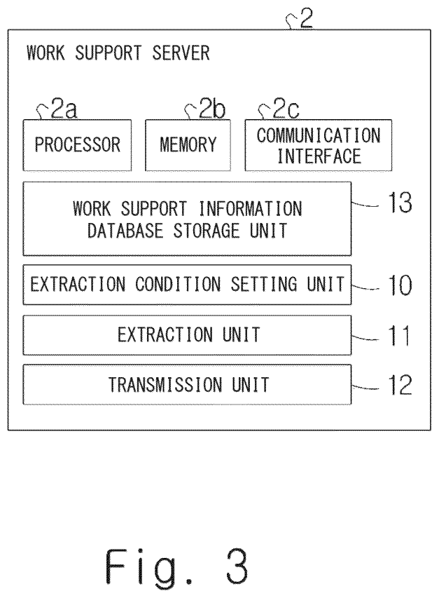

FIG. 3 is a block diagram of the work support server 2. As illustrated in FIG. 3, the work support server 2 includes a processor 2a, a memory 2b, and a communication interface 2c. The processor 2a is accessible to the memory 2b. The processor 2a communicates with the input apparatus 3 and the augmented reality equipment 4 via the communication interface 2c. The processor 2a reads a program stored in the memory 2b and executes the read program. As a result, the program causes hardware such as the processor 2a, the memory 2b, and the communication interface 2c to function as an extraction condition setting unit 10, an extraction unit 11, and a transmission unit 12. The memory 2b functions as a work support information database storage unit 13.

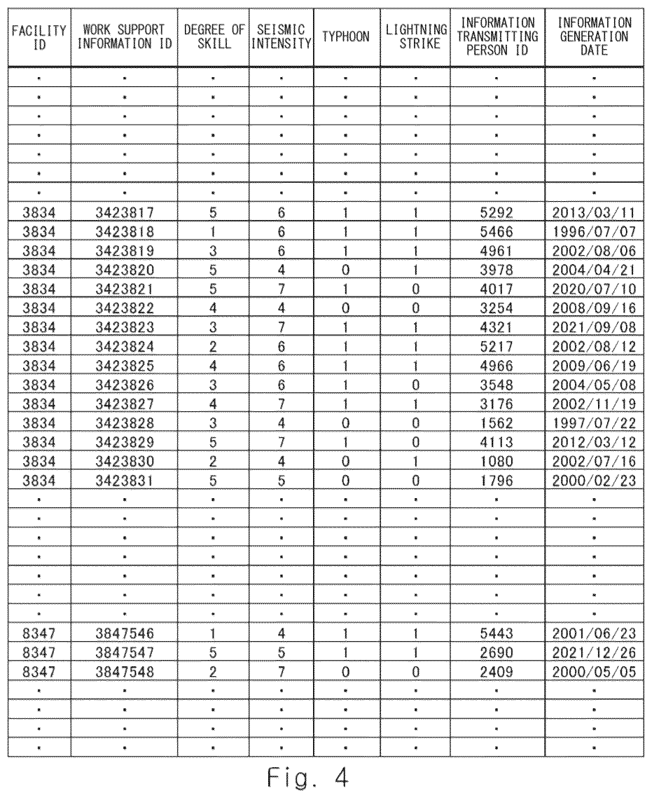

The work support information database storage unit 13 stores a work support information database. FIG. 4 illustrates a data structure diagram of the work support information database. As illustrated in FIG. 4, the work support information database associates a “facility ID”, a “work support information ID”, a “degree of skill”, “seismic intensity”, a “typhoon”, a “lightning strike”, an “information transmitting person ID”, and an “information generation date” with one another.

The “facility ID” is facility identification information for identifying a facility. The “work support information ID” is work support information identification information for identifying work support information. The work support information is typically at least any one of a manual (work process information) of work performed by a worker in an associated facility, a history of a past trouble in the associated facility, and a comment of a skilled worker. The “degree of skill” is degree-of-skill information indicating a degree of skill of a worker. The degree of skill of a worker is typically expressed in five stages. For example, when a worker is a skilled worker, the degree of skill of the worker is “5”. For example, when a worker is an inexperienced worker, the degree of skill of the worker is “1”. The “seismic intensity” is seismic intensity information indicating the seismic intensity of an earthquake. The “typhoon” is typhoon information indicating presence or absence of a typhoon. The “lightning strike” is lightning strike information indicating presence or absence of a lightning strike. The “information transmitting person ID” is generation person identification information for identifying a person who generated associated work support information. The “information generation date” is generation date information indicating a generation date of associated work support information.

Some pieces of work support information may include summary work support information and detailed work support information. When a highly skilled worker engages in work, the detailed work support information may not be required, and summary work support information may be sufficient. On the other hand, when an inexperienced worker engages in work, the detailed work support information may be required. Some pieces of work support information may be work process information. In this case, the work process information may include summary work process information and detailed work process information. The summary work process information is one specific example of first work process information. The detailed work process information is one specific example of second work process information. The detailed work support information is more specific information than the summary work support information. When a work process is configured by a plurality of processes, the summary work process information is configured by only titles of the plurality of processes. In contrast, the detailed work process information may include a detailed implementation guideline for each process in addition to the titles of the plurality of processes.

The extraction condition setting unit 10 sets an extraction condition at a time of extracting at least one piece of work support information from the work support information database illustrated in FIG. 4. The extraction condition setting unit 10 receives work-related information from the input apparatus 3. The extraction condition setting unit 10 sets an extraction condition, based on the work-related information.

The work-related information typically includes the facility ID, the degree of skill of a worker, and the work date. In this case, the extraction condition setting unit 10 sets the facility ID as a first extraction condition. The extraction condition setting unit 10 sets, as a second extraction condition, the degree of skill being higher than a degree of skill of a worker indicated by the work-related information.

The extraction condition setting unit 10 acquires, by accessing a not-illustrated weather database, a disaster history of seven days retroactively from a work date in a facility associated to the facility ID. Then, when an earthquake has occurred in the facility within seven days retroactively from the work date, the extraction condition setting unit 10 sets the seismic intensity of the earthquake as a third extraction condition. For example, when an earthquake having seismic intensity of 5 has occurred in the facility within seven days retroactively from the work date, the extraction condition setting unit 10 sets the third extraction condition in such a way as to extract the work support information whose “seismic intensity” is 5 or more. As a result, it is possible to extract the work support information related to a facility to be inspected intensively when a relatively large earthquake occurs.

Further, when a typhoon has occurred in the facility within seven days retroactively from the work date, the extraction condition setting unit 10 sets a fourth extraction condition in such a way as to extract the work support information whose “typhoon” in the work support information database is 1. As a result, it is possible to extract the work support information related to a facility to be inspected intensively when a typhoon occurs.

Further, when a lightning strike has occurred in the facility within seven days retroactively from the work date, the extraction condition setting unit 10 sets a fifth extraction condition in such a way as to extract the work support information whose “lightning strike” in the work support information database is 1. As a result, it is possible to extract the work support information related to a facility to be inspected intensively when a lightning strike occurs.

Further, the extraction condition setting unit 10 may set a sixth extraction condition using the information transmitting person ID as a key. As a result, it is possible to extract the work support information transmitted by a person being important to the facility.

Further, the extraction condition setting unit 10 may set a seventh extraction condition in such a way as to extract the work support information whose information generation date is after a time of a predetermined number of years back from the work date. As a result, too old work support information can be excluded from an extraction target.

The extraction unit 11 extracts at least one piece of work support information from the work support information database according to at least the first extraction condition. In addition to the first extraction condition, the extraction unit 11 extracts at least one piece of work support information from the work support information database according to at least any one of extraction conditions set by the extraction condition setting unit 10. The at least any one of extraction conditions is at least any one of the second to seventh extraction conditions.

The transmission unit 12 transmits the at least one piece of work support information extracted by the extraction unit 11 to the augmented reality equipment 4.

FIG. 5 is a block diagram of the input apparatus 3. As illustrated in FIG. 5, the input apparatus 3 includes a processor 3a, a memory 3b, a communication interface 3c, a liquid crystal display (LCD) 3d, and an input interface 3e. The processor 3a is accessible to the memory 3b. The processor 3a communicates with the work support server 2 and the augmented reality equipment 4 via the communication interface 3c. The processor 3a reads a program stored in the memory 3b and executes the read program. As a result, the program causes hardware such as the processor 3a, the memory 3b, the communication interface 3c, the LCD 3d, and the input interface 3e to function as a work-related information acceptance unit 20, and a work-related information transmission unit 21.

The work-related information acceptance unit 20 accepts the work-related information input via the input interface 3e. As described above, the work-related information typically includes the facility ID, the degree of skill of a worker, and the work date.

The work-related information transmission unit 21 transmits the work-related information accepted by the work-related information acceptance unit 20 to the work support server 2.

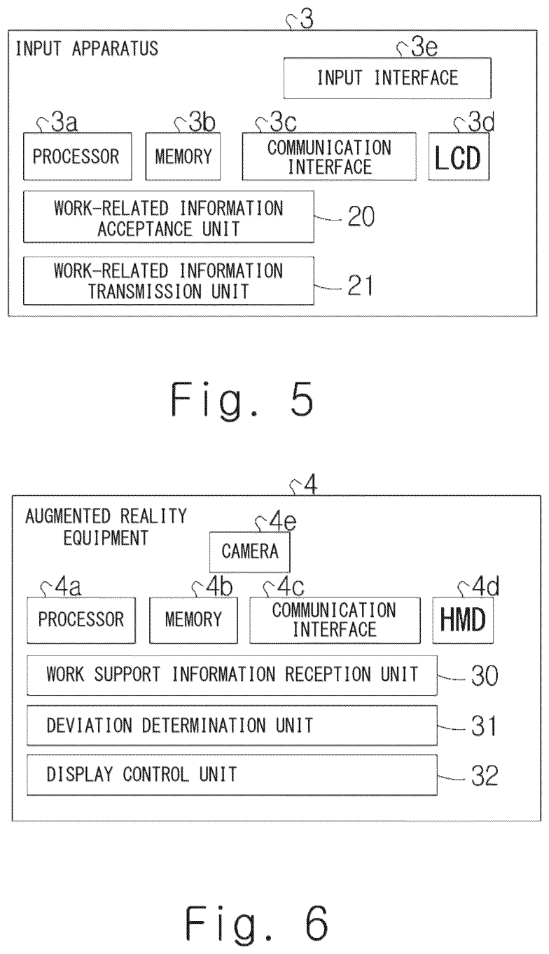

FIG. 6 is a block diagram of the augmented reality equipment 4. The augmented reality equipment 4 is electronic equipment being capable of applying an augmented reality function, and is typically a smartphone, a tablet, or smartglasses. In the present example embodiment, a case where the augmented reality equipment 4 is smartglasses will be described. The augmented reality equipment 4 includes a processor 4a, a memory 4b, a communication interface 4c, a retinal projection type head mounted display (HMD) 4d, and a camera 4e. The processor 4a is accessible to the memory 4b. The processor 4a communicates with the work support server 2 and the input apparatus 3 via the communication interface 4c. The processor 4a reads a program stored in the memory 4b and executes the read program. As a result, the program causes hardware such as the processor 4a, the memory 4b, the communication interfaces 4c, the HMD 4d, and the camera 4e to function as a work support information reception unit 30, a deviation determination unit 31, and a display control unit 32. The camera 4e captures an image in front of a worker wearing the augmented reality equipment 4.

The work support information reception unit 30 receives at least one piece of work support information from the work support server 2.

The deviation determination unit 31 determines, by monitoring work performed by a worker, whether the work performed by the worker deviates from a prescribed work process. The deviation determination unit 31 typically monitors work performed by a worker, based on a camera image output from the camera 4e. Specifically, the deviation determination unit 31 monitors work performed by a worker by identifying a facility or a component captured in a camera image, a facility that the worker is working, based on a QR code (registered trademark) attached to a tool, a component and a tool being handled by the worker. In place of this, the deviation determination unit 31 may identify a facility, a component, or a tool captured in the camera image by using a known object detection technique, and thereby identify a facility that a worker is working, a component and a tool being handled by the worker. The object detection technique typically includes regions with convolutional neural networks (R-CNN) and you only look once (YOLO).

The display control unit 32 displays at least one piece of work support information on the HMD 4d. When the work support information includes the summary work process information and the detailed work process information, the display control unit 32 displays the summary work process information or the detailed work process information, based on a determination result by the deviation determination unit 31. Specifically, when work by a worker does not deviate from a work process prescribed by the detailed work process information, the display control unit 32 displays the summary work process information on the HMD 4d and also does not display the detailed work support information on the HMD 4d. On the other hand, when work by a worker deviates from a work process prescribed by the detailed work process information, the display control unit 32 displays the detailed work process information on the HMD 4d. In this case, the display control unit 32 may display the detailed work process information on the HMD 4d in place of the summary work process information, or may display the detailed work process information on the HMD 4d in addition to the summary work process information.

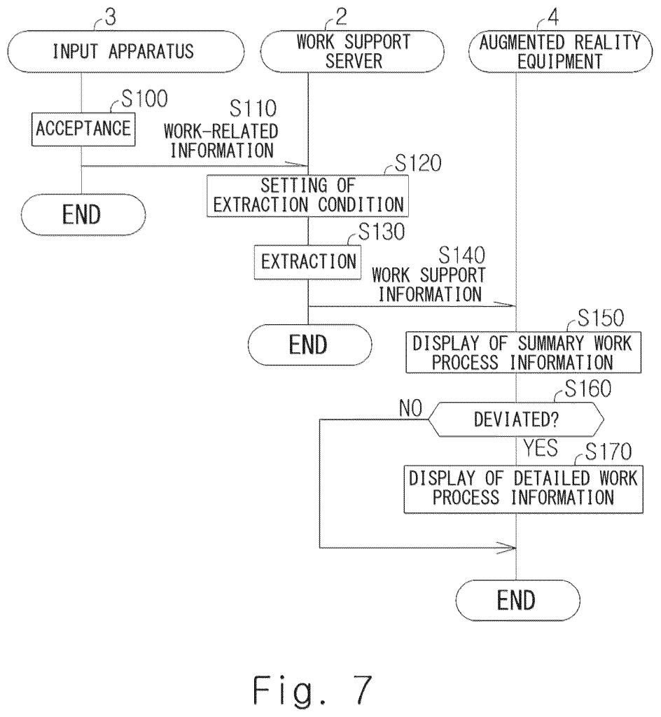

Next, a control flow of the work support system 1 will be described with reference to FIG. 7.

### S100:

First, the work-related information acceptance unit 20 of the input apparatus 3 accepts work-related information input via the input interface 3e. As described above, the work-related information typically includes the facility ID, the degree of skill of a worker, and the work date.

### S110:

Next, the work-related information transmission unit 21 of the input apparatus 3 transmits the work-related information accepted by the work-related information acceptance unit 20 to the work support server 2. The extraction condition setting unit 10 of the work support server 2 receives the work-related information from the input apparatus 3.

### S120:

Next, the extraction condition setting unit 10 of the work support server 2 sets an extraction condition, based on the work-related information received from the input apparatus 3.

### S130:

Next, the extraction unit 11 of the work support server 2 extracts at least one piece of work support information from the work support information database according to the extraction condition set by the extraction condition setting unit 10.

### S140:

Next, the transmission unit 12 of the work support server 2 transmits the at least one work support information extracted by the extraction unit 11 to the augmented reality equipment 4. The work support information reception unit 30 of the augmented reality equipment 4 receives at least one piece of work support information from the work support server 2.

### S150:

Next, the display control unit 32 of the augmented reality equipment 4 displays the at least one piece of work support information received by the work support information reception unit 30 on the HMD 4d. Specifically, when the work support information includes summary work process information and detailed work process information, the display control unit 32 first displays the summary work process information on the HMD 4d.

### S160:

Next, the deviation determination unit 31 of the augmented reality equipment 4 determines whether work by a worker deviates from a work process prescribed by the detailed work process information.

### S170:

In S160, when the deviation determination unit 31 of the augmented reality equipment 4 determines that the work performed by the worker deviates from the work process prescribed by the detailed work process information, the display control unit 32 of the augmented reality equipment 4 displays the detailed work process information on the HMD 4d in place of the summary work process information or in addition to the summary work process information, and ends processing. On the other hand, in S160, when the deviation determination unit 31 of the augmented reality equipment 4 determines that the work performed by the worker does not deviate from the work process prescribed by the detailed work process information, the display control unit 32 of the augmented reality equipment 4 ends processing.

The first example embodiment has been described above. The example embodiment described above has the following feature.

The work support server 2 (work support system) includes the extraction unit 11 and the transmission unit 12. The extraction unit 11 extracts at least one piece of work support information, according to an extraction condition, from a work support information database storing a plurality of pieces of work support information. The transmission unit 12 transmits the at least one piece of work support information extracted by the extraction unit 11 to the augmented reality equipment 4. The extraction condition is at least any one of a degree of skill of a worker using the augmented reality equipment 4, a weather history at a work site, a generation date of the work support information, and an information transmitting person of the work support information. According to the above configuration, it is possible to provide a worker carrying augmented reality equipment with optimized work support information.

When the extraction condition is a weather history, the weather history is a history of a disaster that has occurred before the work date in the work site. According to the above configuration, it is possible to provide a worker carrying the augmented reality equipment with the work support information associated to a past disaster.

The disaster is any one of an earthquake, a typhoon, and a lightning strike. According to the above configuration, it is possible to provide a worker carrying the augmented reality equipment with the work support information associated to any one of an earthquake, a typhoon, and a lightning strike occurred in past.

When the disaster is an earthquake, the extraction unit 11 extracts at least one piece of work support information according to the seismic intensity of the earthquake. According to the above configuration, it is possible to provide a worker carrying the augmented reality equipment with the work support information associated to the seismic intensity of a past earthquake.

The at least one piece of work support information includes summary work process information (first work process information), and detailed work process information (second work process information being more specific information than the first work process information). The augmented reality equipment 4 includes the deviation determination unit 31 and the display control unit 32. The deviation determination unit 31 determines whether work by a worker deviates from a work process prescribed by the detailed work process information. The display control unit 32 displays the summary work process information or the detailed work process information, based on a determination result of the deviation determination unit 31. According to the above configuration, it is possible to display optimum work support information according to a situation of work by a worker.

When the work by the worker does not deviate from the work process prescribed by the detailed work process information, the display control unit 32 displays the summary work process information and also does not display the detailed work process information. When the work by the worker deviates from the work process prescribed by the detailed work process information, the display control unit 32 displays the detailed work process information in place of the summary work process information or in addition to the summary work process information. According to the above configuration, it is possible to display optimum work support information according to a situation of work by a worker. In other words, the display control unit 32 reduces information to be displayed as much as possible, and also displays necessary information as necessary without excess or deficiency.

A program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

An example advantage according to the above-described example embodiment is that it is possible to provide optimized work support information to a worker carrying augmented reality equipment.

Although the present disclosure has been described with reference to the example embodiment, the present disclosure is not limited to the above-described example embodiment. Various changes that can be understood by a person skilled in the art within the scope of the present disclosure can be made to the configuration and details of the present disclosure.

Each drawing is merely exemplification of one or more of example embodiments. Each drawing may be associated with one or more of other example embodiments, rather than only one particular example embodiment. As those skilled in the art will appreciate, various features or steps described with reference to any one of the drawings can be combined with features or steps illustrated in one or more of the other drawings, for example, to create an example embodiment not explicitly illustrated or described. All of the features or steps illustrated in any one of the drawings to describe the example embodiment are not necessarily essential, and some features or steps may be omitted. An order of the steps described in any of the drawings may be changed as appropriate.

Some or all of the above-described example embodiment may be described as the following supplementary notes, but are not limited thereto.

### Supplementary Note 1

A work support system including:

an extraction means for extracting at least one piece of work support information, according to an extraction condition, from a work support information database storing a plurality of pieces of work support information; and

a transmission means for transmitting the at least one piece of work support information extracted by the extraction means to augmented reality equipment, wherein

the extraction condition is at least any one of a degree of skill of a worker using the augmented reality equipment, a weather history at a work site, a generation date of the work support information, and an information transmitting person of the work support information.

### Supplementary Note 2

The work support system according to supplementary note 1, wherein, when the extraction condition is the weather history, the weather history is a history of a disaster occurring before a work date in the work site.

### Supplementary Note 3

The work support system according to supplementary note 2, wherein the disaster is any one of an earthquake, a typhoon, and a lightning strike.

### Supplementary Note 4

The work support system according to supplementary note 3, wherein, when the disaster is an earthquake, the extraction means extracts the at least one piece of work support information according to seismic intensity of an earthquake.

### Supplementary Note 5

The augmented reality equipment according to supplementary note 1, wherein the at least one piece of work support information includes a first work process information, and a second work process information being more specific information than the first work process information,

the augmented reality equipment including:
a deviation determination means for determining whether work by the worker deviates from a work process prescribed by the second work process information; and
a display control means for displaying the first work process information or the second work process information, based on a determination result of the deviation determination means.

### Supplementary Note 6

The augmented reality equipment according to supplementary note 5, wherein the display control means, when work by the worker does not deviate from a work process prescribed by the second work process information, displays the first work process information and also does not display the second work process information, and when work by the worker deviates from a work process prescribed by the second work process information, displays the second work process information in place of the first work process information or in addition to the first work process information.

### Supplementary Note 7

A work support apparatus including:
an extraction means for extracting at least one piece of work support information, according to an extraction condition, from a work support information database storing a plurality of pieces of work support information; and
a transmitting means for transmitting the at least one piece of work support information extracted by the extraction means to augmented reality equipment, wherein
the extraction condition is at least any one of a degree of skill of a worker using the augmented reality equipment, a weather history at a work site, a generation date of the work support information, and an information transmitting person of the work support information.

### Supplementary Note 8

The work support apparatus according to supplementary note 7, wherein, when the extraction condition is the weather history, the weather history is a history of a disaster occurring before a work date in the work site.

### Supplementary Note 9

The work support apparatus according to supplementary note 8, wherein the disaster is any one of an earthquake, a typhoon, and a lightning strike.

### Supplementary Note 10

The work support apparatus according to supplementary note 9, wherein, when the disaster is an earthquake, the extraction means extracts the at least one piece of work support information according to seismic intensity of an earthquake.

### Supplementary Note 11

The augmented reality equipment according to supplementary note 7, wherein the at least one piece of work support information includes a first work process information, and a second work process information being more specific information than the first work process information,

the augmented reality equipment including:
a deviation determination means for determining whether work by the worker deviates from a work process prescribed by the second work process information; and
a display control means for displaying the first work process information or the second work process information, based on a determination result of the deviation determination means.

### Supplementary Note 12

The augmented reality equipment according to supplementary note 11, wherein the display control means, when work by the worker does not deviate from a work process prescribed by the second work process information, displays the first work process information and also does not display the second work process information, and when work by the worker deviates from a work process prescribed by the second work process information, displays the second work process information in place of the first work process information or in addition to the first work process information.

### Supplementary Note 13

A work support method including,

by a computer:
extracting at least one piece of work support information, according to an extraction condition, from a work support information database storing a plurality of pieces of work support information; and
transmitting the extracted at least one piece of work support information to augmented reality equipment, wherein

the extraction condition is at least any one of a degree of skill of a worker using the augmented reality equipment, a weather history at a work site, a generation date of the work support information, and an information transmitting person of the work support information.

### Supplementary Note 14

The work support method according to supplementary note 13, wherein, when the extraction condition is the weather history, the weather history is a history of a disaster occurring before a work date in the work site.

### Supplementary Note 15

The work support method according to supplementary note 14, wherein the disaster is any one of an earthquake, a typhoon, and a lightning strike.

### Supplementary Note 16

The work support method according to supplementary note 15, further including, when the disaster is an earthquake, extracting the at least one piece of work support information according to seismic intensity of an earthquake.

### Supplementary Note 17

A program causing a computer to function as:

an extraction means for extracting at least one piece of work support information, according to an extraction condition, from a work support information database storing a plurality of pieces of work support information; and

a transmitting means for transmitting the at least one piece of work support information extracted by the extraction means to augmented reality equipment, wherein

the extraction condition is at least any one of a degree of skill of a worker using the augmented reality equipment, a weather history at a work site, a generation date of the work support information, and an information transmitting person of the work support information.

### Supplementary Note 18

The program according to supplementary note 17, wherein, when the extraction condition is the weather history, the weather history is a history of a disaster occurring before a work date in the work site.

### Supplementary Note 19

The program according to supplementary note 18, wherein the disaster is any one of an earthquake, a typhoon, and a lightning strike.

### Supplementary Note 20

The program according to supplementary note 19, wherein, when the disaster is an earthquake, the extraction means extracts the at least one piece of work support information according to seismic intensity of an earthquake.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. A work support system comprising:
at least one first memory storing instructions, and
at least one first processor configured to execute the instructions to;
extract at least one piece of work support information, according to an extraction condition, from a work support information database storing a plurality of pieces of work support information; and
transmit the at least one piece of work support information extracted by the extraction means to augmented reality equipment, wherein
the extraction condition is at least any one of a degree of skill of a worker using the augmented reality equipment, a weather history at a work site, a generation date of the work support information, and an information transmitting person of the work support information.

2. The work support system according to claim 1, wherein, when the extraction condition is the weather history, the weather history is a history of a disaster occurring before a work date in the work site.

3. The work support system according to claim 2, wherein the disaster is any one of an earthquake, a typhoon, and a lightning strike.

4. The work support system according to claim 3, wherein, when the disaster is an earthquake, the at least one first processor is further configured to execute the instructions to extract the at least one piece of work support information according to seismic intensity of an earthquake.

5. The augmented reality equipment according to claim 1, wherein the at least one piece of work support information includes a first work process information, and a second work process information being more specific information than the first work process information,
the augmented reality equipment comprising:
at least one second memory storing instructions, and
at least one second processor configured to execute the instructions to;
determine whether work by the worker deviates from a work process prescribed by the second work process information; and
display the first work process information or the second work process information, based on a determination result of the deviation determination means.

6. The augmented reality equipment according to claim 5, wherein the at least one second processor is further configured to execute the instructions to display, when work by the worker does not deviate from a work process prescribed by the second work process information, the first work process information and also not to display the second work process information, and
to display, when work by the worker deviates from a work process prescribed by the second work process information, the second work process information in place of the first work process information or in addition to the first work process information.

7. A work support apparatus comprising:
at least one first memory storing instructions, and
at least one first processor configured to execute the instructions to;
extract at least one piece of work support information, according to an extraction condition, from a work support information database storing a plurality of pieces of work support information; and
transmit the at least one piece of work support information extracted by the extraction means to augmented reality equipment, wherein
the extraction condition is at least any one of a degree of skill of a worker using the augmented reality equipment, a weather history at a work site, a generation date of the work support information, and an information transmitting person of the work support information.

8. A work support method comprising,
by a computer:
extracting at least one piece of work support information, according to an extraction condition, from a work support information database storing a plurality of pieces of work support information; and
transmitting the extracted at least one piece of work support information to augmented reality equipment, wherein
the extraction condition is at least any one of a degree of skill of a worker using the augmented reality equipment, a weather history at a work site, a generation date of the work support information, and an information transmitting person of the work support information.

9. A non-transitory computer-readable storage medium storing a program for causing a computer to execute the computer-implemented work support method according to claim 8.
